(19) United States
(12) Patent Application Publication
(10) Pub. No.: US 2016/0341847 A1
(43) Pub. Date: Nov. 24, 2016

(54) Ultra-Portable People Screening System

(71) Applicant: Rapiscan Systems, Inc., Torrance, CA (US)

(72) Inventors: Luis E. Arroyo, Jr., Ashburn, VA (US); Dan Strellis, San Jose, CA (US); Willem G. J. Langeveld, Menlo Park, CA (US)

(73) Assignee: Rapiscan Systems, Inc., Torrance, CA (US)

(21) Appl. No.: 13/942,563

(22) Filed: Jul. 15, 2013

Related U.S. Application Data
(60) Provisional application No. 61/671,991, filed on Jul. 16, 2012.

(51) Int. Cl. G01V 5/00; G21K 1/04

(52) U.S. Cl. CPC G01V 5/0025; G21K 1/04

(57) ABSTRACT

The present specification describes security systems for screening threats contained on persons, and more specifically, to an integrated detection system that is highly portable and that employs Enhanced Metal Detection (EMD) along with Advanced Imaging Technology (using backscatter X-ray scanning) to achieve Automated Threat Recognition (ATR) improvements. In particular, the present specification describes a modular inspection system for detecting objects carried by or on a human subject that includes a plurality of sections having an X-ray source, two backscatter X-ray detector panels and at least one metal detector panel; a first strapping means to hold together two of the plurality of sections that are folded and form a portable first case; and a second strapping means to hold together two of the plurality of sections that are folded and form a portable second case such that the first and second cases can be wheeled to and from a checkpoint.

### CROSS-REFERENCE TO RELATED APPLICATIONS

The present specification relies upon, for priority, United States Provisional Patent Application No. 61/671,991, entitled “Ultra-Portable People Screening System” and filed on Jul. 16, 2012.

### FIELD

The invention relates generally to security systems for screening threats contained on persons, and more specifically, to an integrated detection system that is highly portable and that employs Enhanced Metal Detection (EMD) along with Advanced Imaging Technology (using backscatter X-ray scanning) to achieve Automated Threat Recognition (ATR) improvements.

### BACKGROUND

Security systems are presently limited in their ability to detect contraband, weapons, explosives, and other dangerous objects concealed under clothing. Metal detectors and chemical sniffers are commonly used for the detection of large metal objects and certain types of explosives; however, a wide range of dangerous objects exist that cannot be detected using these devices. Plastic and ceramic weapons increase the types of non-metallic objects that security personnel are required to detect. Manual searching of subjects is slow, inconvenient, and is not well-tolerated by the general public, especially as a standard procedure in high traffic centers.

It is well-known in the art that images of various types of material can be generated using X-ray scattering. The intensity of scattered X-rays is related to the atomic number (Z) of the material scattering the X-rays. In general, for atomic numbers less than 25, the intensity of X-ray backscatter, or X-ray reflectance, decreases with increasing atomic number. Images are primarily modulated by variations in the atomic number of the subject's body. Low-Z materials present a special problem in personnel inspection because of the difficulty in distinguishing the low-Z object from the background of the subject's body which also is comprised of low-Z materials. Conventional X-ray systems for detecting objects concealed on persons have limitations in their design and method that prohibit them from achieving low radiation doses, which is a health requirement, or prevent the generation of high image quality, which are prerequisites for commercial acceptance. An inspection system that operates at a low level of radiation exposure is limited in its precision by the small amount of radiation that can be directed against a person being searched. X-ray absorption on the subject and scattering (not into the detector) further reduces the amount of X-rays available to form an image of the person and any concealed objects. In prior art systems this low number of detected X-rays has resulted in unacceptably poor image quality.

Further, X-ray screening systems deployed at airports in the United States of America (U.S.A.) for performing automatic threat detection have to comply with guidelines set by the

Transportation Security Administration (TSA). Current TSA guidelines require a screening system to be of minimal footprint such that it is deployable at space-limited checkpoints and also capable of scanning a person at least 6 feet 6 inches tall from elbow to elbow which translates into a scanning width of at least 103 centimeters. Also, given the increasing rush at the airports, a screening system deployed at an airport or other such heavy throughput areas must provide a fast scanning time. Still further, a screening system should preferably be compliant with laws governing disabled persons. In the U.S.A. the screening systems must be compliant with the regulations set forth in the Americans with Disabilities Act (ADA). It should be noted that the Advanced Imaging Technology (AIT) systems currently in use are fixed portal systems that are not conducive for highly portable applications.

Therefore, there is a need for an X-ray screening system that provides good resolution as well as a large range of view and fast scanning speed, while keeping the radiation exposure within safe limits. Also required is a screening system that may be deployed easily by virtue of modularity, smaller size, reduced weight and rapid assembly, while at the same time providing and/or maintaining a high scan speed (and therefore, high personnel throughput) and the latest processing electronics. Further, what is needed is an integrated detection system that employs Enhanced Metal Detection (EMD) and Advanced Imaging Technology (using backscatter X-ray scanning) to achieve Automated Threat Recognition (ATR) improvements.

### SUMMARY

In one embodiment, the present specification describes a modular inspection system, for detecting objects carried by or on a human subject, comprising: first, second, third and fourth sections wherein each said section further comprises an X-ray source with integrated beam chopper, two backscatter X-ray detector panels and at least one metal detector panels; first strapping means to hold together folded said first and second sections and form a portable first case; and second strapping means to hold together folded said third and fourth sections and form a portable second case; wherein the first and second cases can be wheeled to and from a checkpoint.

In one embodiment, each of the said sections comprise at least one cavity for housing a flat panel display along with control unit in one of the said cavities and rechargeable batteries in the remaining said cavities. In one embodiment, the first and second cases are mounted on respective first and second wheeled trolleys with handles. In another embodiment, the first and second cases are protected with first and second transport covers respectively during transportation. In one embodiment, each of the said sections weighs approximately 70 lbs.

In one embodiment, each of the X-ray sources is a lightweight compact source integrated with a spin-roll chopper. In one embodiment, the integrated X-ray source and spin-roll chopper are rotated upon a user-programmable platform. In one embodiment, each of the X-ray sources scans a spot of X-rays over the human subject during backscatter X-ray scanning

In one embodiment, the backscatter X-ray detector panels are flat surfaces covered with scintillating fibers that are read out using photodetectors. In another embodiment, the backscatter X-ray detector panels are one or more flat scintillating screens sandwiching wavelength-shifting fibers that are read out using photodetectors.

In one embodiment, the present specification describes a method for detecting objects carried by or on a human subject, said method comprising the steps of: unfolding first and second sections from a first case and unfolding third and fourth sections from a second case; wherein each of the first, second, third and fourth sections comprise at least one X-ray source with integrated beam chopper, two backscatter X-ray detector panels and at least one metal detector panel; latching the unfolded first section on top of the unfolded second section to form a first side; latching the unfolded third section on top of the unfolded fourth section to form a second side; holding the first and second sides together using two handle assemblies thereby forming the inspection system; allowing the human subject to enter the inspection archway; screening the human subject using the metal detector panels in the said sections to obtain first inspection data; screening the human subject by operating the X-ray sources in the said sections and detecting the backscattered X-rays from the human subject using the backscatter X-ray detector panels to obtain second inspection data; fusing first and second inspection data; and analyzing the fused inspection data to automatically determine and alarm anomalies.

In one embodiment, each of the said sections comprise at least one cavity for housing a flat panel display along with control unit in one of the said cavities and rechargeable batteries in the remaining said cavities. In one embodiment, each of the said sections weighs approximately 70 lbs.

In one embodiment, each of the X-ray sources is a lightweight compact source integrated with a spin-roll chopper. In another embodiment, the integrated X-ray source and spin-roll chopper are rotated upon a platform which is user programmable. In another embodiment, each of the X-ray sources scans a spot of X-rays over the human subject during backscatter X-ray scanning

In one embodiment, the backscatter X-ray detector panels are flat surfaces covered with scintillating fibers that are read out using photodetectors. In another embodiment, the backscatter X-ray detector panels are one or more flat scintillating screens sandwiching wavelength-shifting fibers that are read out using photodetectors.

In one embodiment, assembly of the inspection system takes less than or equal to 5 minutes.

### BRIEF DESCRIPTION OF THE DRAWINGS

These and other features and advantages of the present invention will be appreciated as they become better understood by reference to the following detailed description when considered in connection with the accompanying drawings, wherein:

FIG. 1 illustrates a typical posed backscatter x-ray image;

FIG. 2A illustrates a first section of the screening system of the present invention, which, when joined with a second section, forms one case, in accordance with one embodiment;

FIG. 2B illustrates a first section and a second section of the screening system of the present invention, held by an integrated strapping system, thus forming one case, in accordance with an embodiment of the present invention;

FIG. 2C illustrates two case assemblies of the screening system of the present invention, each formed by strapping together a first section and a second section of the screening system, in accordance with one embodiment;

FIG. 2D shows one case of the screening system of the present invention mounted on a wheeled trolley;

FIG. 2E is an illustration of the case shown in FIG. 2D encompassed within a transport cover;

FIG. 2F illustrates an assembly process of the screening system, in accordance with one embodiment of the present invention;

FIG. 3 illustrates the screening system formed by assembling two cases/assemblies (comprising four total sections), in accordance with an embodiment of the present invention;

FIG. 4 illustrates a beam forming apparatus, and specifically, a spin-roll chopper apparatus, in accordance with an embodiment of the present invention;

FIG. 5 illustrates a top view illustration of the overall footprint of the screening system of the present invention, when deployed and in operation, in accordance with an embodiment;

FIG. 6A illustrates a typical backscatter X-ray image of a human body in accordance with one embodiment of the present invention;

FIG. 6B illustrates a backscatter X-ray image of a human body with an explosive strapped to a left shin, in accordance with one embodiment of the present invention;

FIG. 6C illustrates an avatar with an explosive strapped to the left shin, which represents the backscatter X-ray image of a human body with an explosive strapped to the left shin, in accordance with one embodiment of the present invention;

FIG. 7 illustrates a typical active background x-ray image 700 in accordance with one embodiment of the present invention; and,

FIG. 8 is a flowchart illustrating a method of operation of the screening system of the present invention, according to one embodiment.

### DETAILED DESCRIPTION

The present invention provides an improved system and method of screening individuals at security locations that combines the capability of Advanced Imaging Technology (AIT) and Enhanced Metal Detection (EMD) with Automated Threat Recognition (ATR) enhancements. The screening system of the present invention allows for an AIT system that uses backscatter x-ray imaging technology in conjunction with Walk-Through Metal Detection (WTMD) technology. These technologies are combined into one rugged, portable system enabling effective personnel screening to users requiring both sensitive detection and ultimate portability.

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The screening system of the present invention is based on the X-ray backscatter technology as well as metal detection technology. Backscatter x-ray imaging is a well-established technique for the non-intrusive inspection of vehicles and personnel. In X-ray backscatter systems for detecting concealed objects, a pencil beam of X-rays traverses over the surface of the body of a subject being examined. X-rays that are scattered or reflected from the subject's body are detected by a detector such as, for example, a scintillator and photomultiplier tube combination. The resultant signal produced by the X-ray detector is then used to produce a body image, such as a silhouette, of the subject and any concealed objects carried by the subject. The design of the X-ray backscatter imaging system of the present invention is optimized for near-real time imaging of people or objects with an interrogating radiation beam. The system is also capable of automatically detecting threats by applying detection algorithms on the image data to process the image data in near real-time.

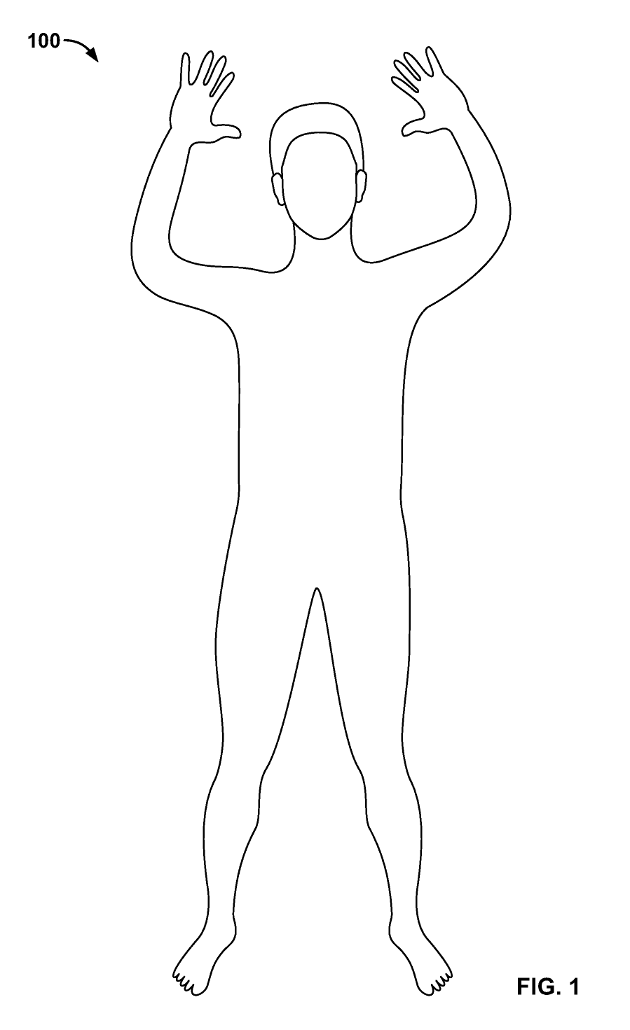

Further, backscatter x-ray imaging method used in the present invention works on the principle that lower-Z (atomic number) materials preferentially Compton scatter x-rays of the source energy while higher-Z materials attenuate (absorb) them. In an embodiment, detectors are placed on the same side of the inspection zone as the x-ray source to detect backscattered x-rays. As a result, lower-Z materials, such as explosives, display as bright objects in the image, while metal guns and knives display as dark objects. FIG. 1 illustrates a typical posed backscatter x-ray image 100.

In its simplest form, a metal detector has a transmitter panel and a receiver panel. In various conventional metal detection systems, the transmitter panels have a plurality of partly overlapping transmitter coils for the generation of oscillating magnetic fields at a specific frequency. In one embodiment, the transmitter panels have eight partly overlapping transmitter coils. Each coil generates a continuous-wave field of a different frequency. Frequencies are located on a noise-free frequency band around 10 kHz. Together with efficient filtering, this leads to high immunity to external electromagnetic interference. The receiver panel has a plurality of receiver coils. In one embodiment, the receiver panel has seventeen receiver coils. The receiver coils measure the changes in the magnetic field generated by a specific transmitter coil caused by a metal object passing through the unit. The metal detectors employed in the present systems are an improvement over such prior art metal detection systems.

The screening system of the present invention utilizes the backscatter imaging and metal detection technologies as core technologies. Since, these technologies are widely deployed at various screening locations such as airports, courthouses, jails, and in combat theaters around the world, they have been exposed to a wide variety of operator uses, environmental conditions, and handling situations.

Further, the present invention employs an ATR algorithm, which uses the data from the combination of the two technologies, as thus, is able to combine screening information from two sources for a more comprehensive screening solution. The screening system of the present invention provides improved usability through reduced footprint, reduced weight, improved portability, and improved performance.

The screening system of the present invention is developed to optimize portability, usability, and maintainability. This system is built from two case assemblies (hereinafter referred to as ‘cases’), each of the two cases further comprising a first section and a second section. In other words, the screening system of the present invention is built from a total of four sections that are paired and packaged in two cases.

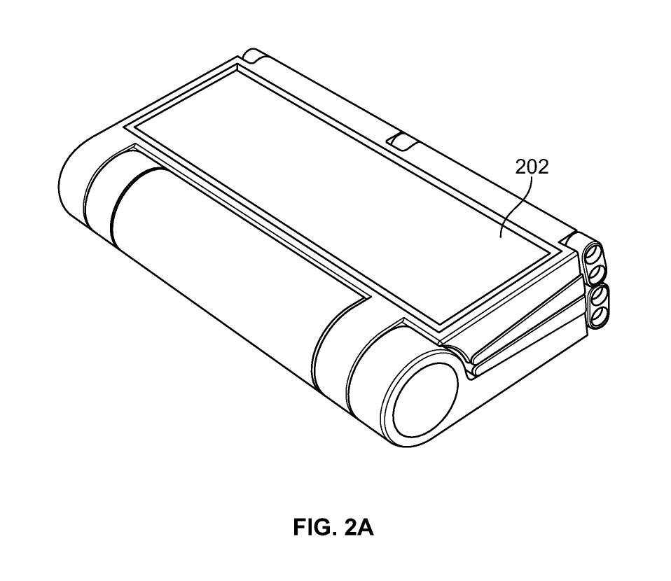

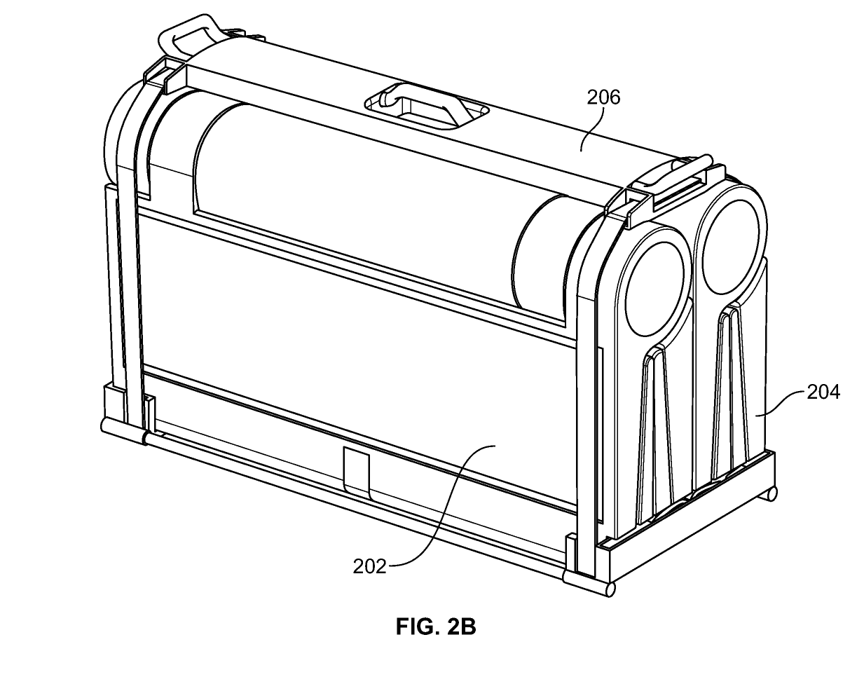

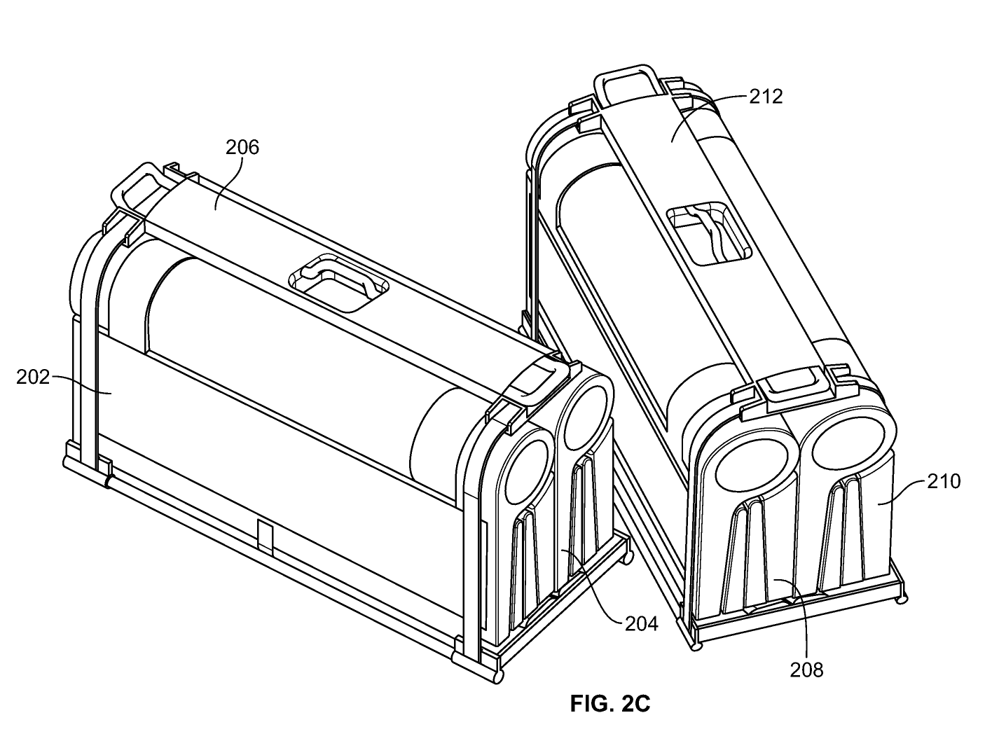

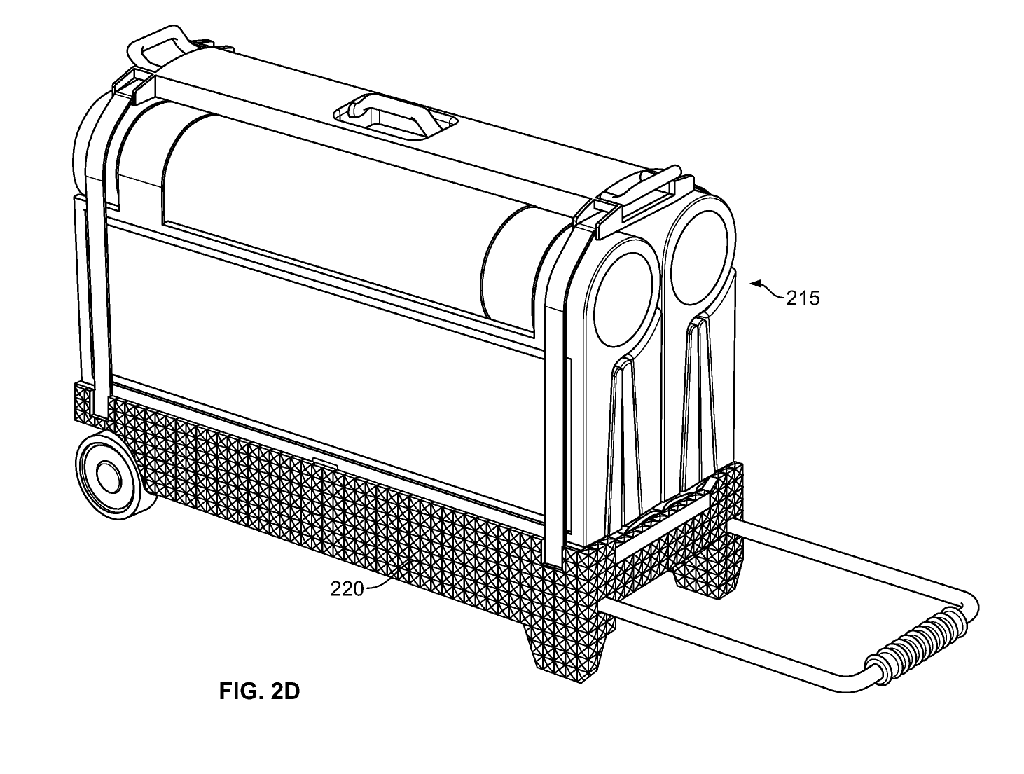

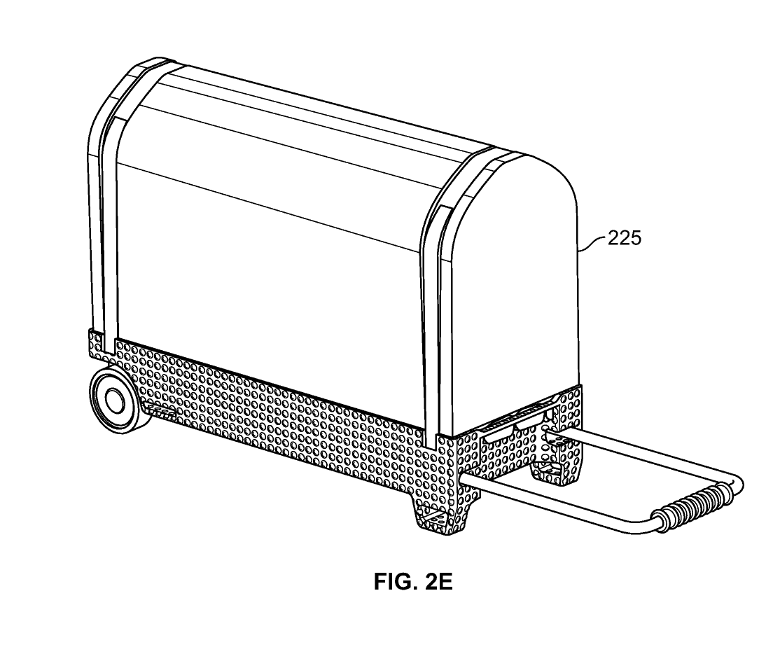

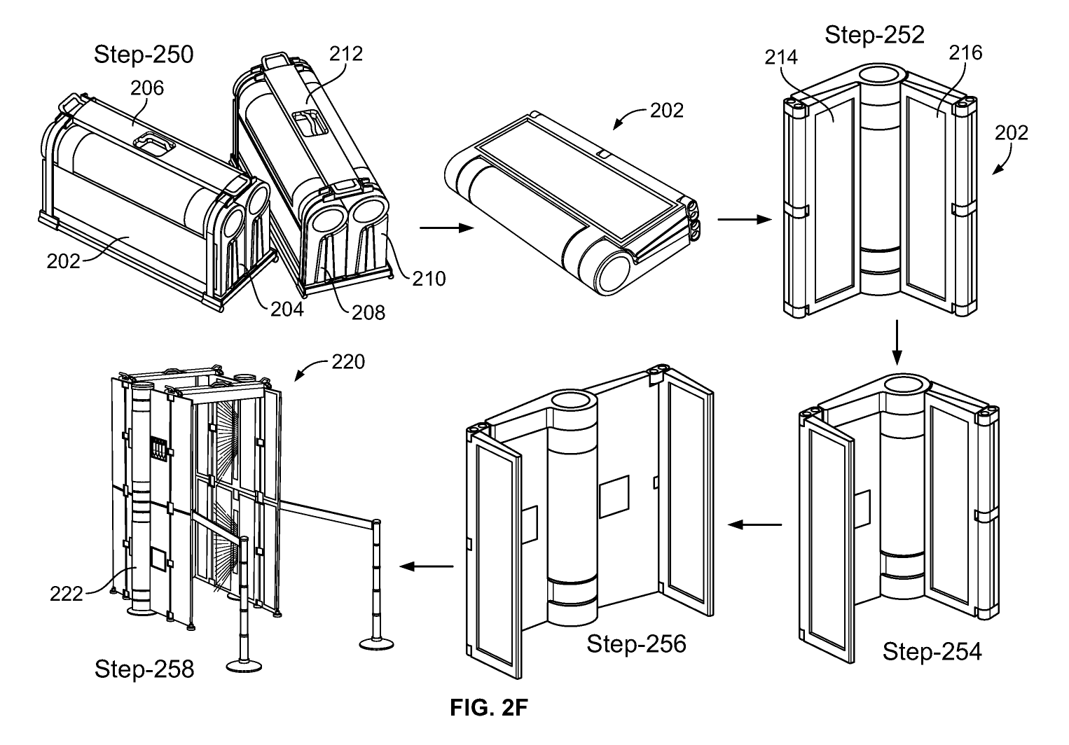

FIG. 2A illustrates a first section 202 forming at least a part of the screening system of the present invention. It should be noted that while a first section 202 is described in detail herein, the remaining three sections are, in one embodiment, identical in dimensions to first section 202, and are comprised of substantially the same components. In an embodiment, the outer dimensions of the first section 202 (and each other section) are approximately 8.5 inches ×24 inches ×43 inches. First section 202 comprises at least one small x-ray source (such as a 50 kV to 80-kV source) and integrated beam forming apparatus (an embodiment of which is discussed in detail below), two x-ray detector panels, at least one metal detector panel, and associated electronics. In an embodiment, at least one, and preferably two, small cavities are designed into each of the four sections and a flat panel display is locked into one cavity of one of the sections, while the remaining cavities are designed to house a power source, which, in one embodiment but not limited to such embodiment, comprises removable, rechargeable batteries. The four sections snap together to form an assembled archway screening system with a combination of EMD and backscatter x-ray imaging capability. Once assembled, the archway screening system of the present invention allows for ingress and egress of subjects from either end.

In an embodiment, in order to simplify transport, two sections—a first section and a second section are held together with an integrated strapping system as illustrated in FIG. 2B. As shown, first section 202 and second section 204 are held together by a strapping mechanism 206 to form a case assembly. Thus, the entire screening system may be transported in two such case assemblies, each having approximate dimensions of 17 inches ×24 inches ×43 inches, as illustrated in FIG. 2C. As shown, sections 202 and 204 are coupled together by using strapping mechanism 206 while two more sections 208 and 210 are coupled together using strapping mechanism 212. In one embodiment, the entire system can be stored and transported in environments with temperatures ranging from −25° C. to +70° C. and with humidity ranging from 0-95% without condensation, noting that special care and consideration must be taken if the rechargeable batteries are present.

In various embodiments, the screening system of the present invention may be deployed quickly at indoor or outdoor checkpoint screening locations. As shown in FIG. 2D, for transport, two sections are bound together with strapping to form a case 215. The case 215, in one embodiment, is mounted on a wheeled trolley 220 with handle or has wheels and a handle so that the entire system can be easily wheeled/pulled, such as by two operators, to an inspection checkpoint.

In one embodiment, as shown in FIG. 2E, a transport cover 225 is used to encompass the case for protection against harsh environmental conditions, such as rain, during transportation.

FIG. 2F illustrates a step-wise assembly process of the screening system of the present invention. The system is assembled, in step 250, by first detaching sections 202 and 204 (which were combined to form case 206) and sections 208 and 210 (which were combined to form case 212) from each other, respectively. In step 252, section 202 is unfolded to expose a left panel 214 and a right panel 216. Left panel 214 and right panel 216 are unfolded further, in steps 254 and 256, exposing the full extent of section 202. Sections 204, 208, and 210 are unfolded in a similar fashion (not shown). In step 258, a first section, such as section 202, is positioned and latched atop a second section, such as section 208 forming a side 220 and a first section, such as section 204 is positioned and latched atop a second section, such as section 210, to form a side 222. As shown, in step 258, the two combined sections 220 and 222 (left and right sides, respectively) are placed opposite one another to form a scanning portal through which a subject walks. In an optional embodiment, a connecting rod or hood is used to connect both the right side and the left side.

In one embodiment, setup time is no more than 5 minutes. In one embodiment, the system can be operated indoors and outdoors with a user-provided protected cover (i.e. tent or canopy). In one embodiment, the system can be operated in environments with temperatures ranging from −10° C. to +65° C., humidity ranging from 0-95% without condensation, and winds speeds up to 20 mph.

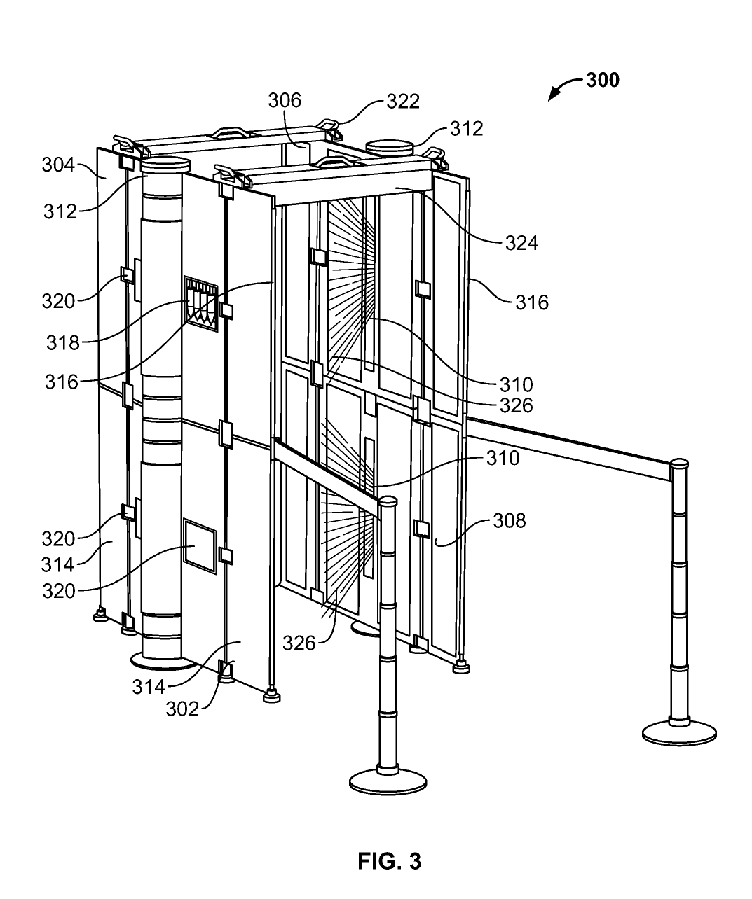

FIG. 3 illustrates the screening system formed by assembling the four sections, in accordance with an embodiment of the present invention. In one embodiment, the sections weigh approximately 70 lbs each, and their unique mechanical connectors ensure that the system is assembled correctly. In one embodiment, the mechanical connectors are coded, such as by letter, number, or color to ensure proper attachment. As illustrated the assembled system 300 comprises four sections 302, 304, 306 and 308 which are connected to form an archway. Each section comprises a compact x-ray source and an integrated beam chopper. Each of the four compact x-ray sources and integrated beam choppers produce a horizontally pivoting flying-spot x-ray beam 310 that together images the entire body of any stationary subject placed between the four sections. In an embodiment, a complete x-ray scan takes approximately 8 seconds. Indicator lights 312 illuminate the system status, including when an x-ray scan is in progress.

In one embodiment, a pair of WTMD panels 314 for each section contains transmission coils on one side and receiver coils on the other side, providing enhanced metal detection at the system entrance and exit upon assembly. In an optional embodiment, each section contains one WTMD sub-system, such that enhanced metal detection is provided at either the system entrance or exit. In accordance with an embodiment of the present invention, each set of transmission and receiver coils has a separation at the horizontal mid-line to support the portable packaging of the sections into cases. The WTMD screening occurs as a subject enters and/or exits the system. In one embodiment, vertical LED displays 316 are provided on at least one WTMD panels 314. In one embodiment, the vertical LED displays 316 are used to indicate system status. In another embodiment, vertical LED displays 316 are used to provide immediate feedback on the location of a metal detection alarm.

In an embodiment, the screening system of the present invention employs an improved metal detection system wherein a new detection coil system with an increased number of detection channels for enhanced detection performance is used. Further, the improved metal detection system used herein has been made immune to electromagnetic interference by use of continuous wave excitation and a higher frequency range instead of the pulsed field excitation which is used in prior art metal detection systems. This enables the screening system to operate in environments where the system is operated in proximity to other electrical equipment and screening devices. In one embodiment, the system can operate within 2 to 4 feet of commercially available walk-through metal detectors, handheld metal detectors, baggage x-ray machines, and radio communication equipment and not adversely affect performance of same.

In one embodiment of the present invention, the metal detection sub-system is continuously active. At no time is it possible to toss, pass or slide a weapon through undetected. No photoelectric, infrared, or other sensor device is used to enable and disable the detection circuitry and thus mask the impact of external interference. Also, the coil system has several overlapping coils to minimize the effect of object orientation to signal level. Optionally, a dedicated subsystem handles detection on the lower part to maximize discrimination of shoe shanks For location display there is yet another subsystem of coils. This removes the need to make compromises to the detection capabilities of the main coil system to enable location display.

In another embodiment of the present invention, the metal detection sub-system is inactive during at least a portion of the scanning process.

In an embodiment, a control unit and image display 318 is clipped into one of the eight case cavities while a power supply is clipped into some or all of the other seven cavities 320. In one embodiment, the power supply includes a battery source. In one embodiment, the system includes an option for remote control and remote display monitoring. Further, a dual use archway bridge is provided for stabilizing the assembled system along with handles 322 for case transport. In addition, in an optional embodiment, the archway bridge comprises a drop-down x-ray radiation banner 324 indicating when x-rays are being generated. In one optional embodiment, tower lights and lights within the system are used to indicate when x-rays are on. In an embodiment, shore power may be supplied to the assembled system through a rugged 120 V or 220 V AC power cable. Accordingly, in one embodiment, the screening system of the present invention can be configured to operate on either commercial AC power or battery power. In one embodiment, the system includes a plurality of emergency-off buttons located at multiple positions that are accessible to the screeners. In one embodiment, the system includes radiation interlocks connected to the x-ray source to ensure that x-rays are produced only when required.

In various embodiments of the present invention, a plurality of compact x-ray sources that scan a spot of x-rays over the subject are used. Each x-ray source scans the x-ray spot over only a fraction of the subject as indicated by the fan shapes 326 in FIG. 3. Since the source of x-rays is close to the body of the subject being scanned, image clarity (both signal level and resolution) is maintained. Further, by using multiple individual x-ray sources, the weight of the x-ray sources can be distributed into the multiple transportable sections described above. Therefore, the need of an elevator to move the x-ray source, which is common in the prior art, is eliminated. Since multiple x-ray sources are employed, each one needs to be light in order to maintain a reasonable overall system weight.

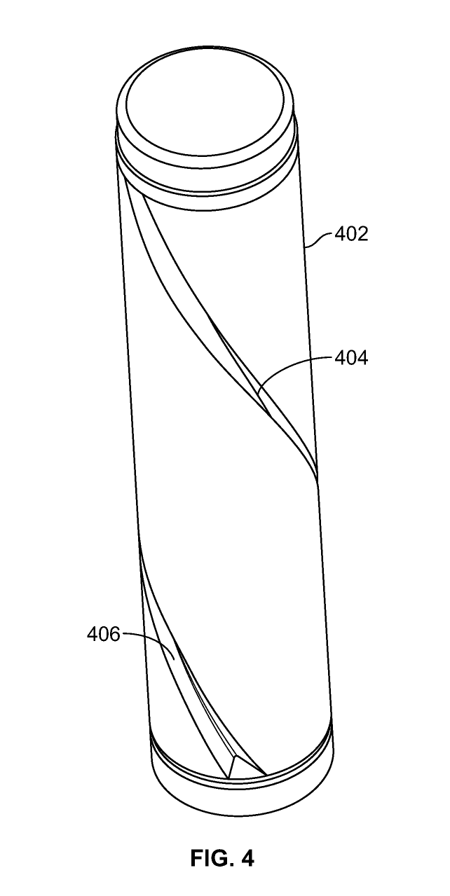

A lightweight source is achieved in the present system by using a compact x-ray source and a novel beam chopping system referred to as the “spin-roll” chopper that effectively replaces the disc wheel chopper. FIG. 4 illustrates a spin-roll chopper, in accordance with an embodiment of the present invention. The spin roll chopper comprises a rotating cylinder 402 with two slits 404 and 406, whereby when the cylinder 402 is mounted in front of a collimated fan beam of x-rays, the x-rays project through the slits to form a diamond-shaped spot. As the cylinder spins along the long axis, the diamond-shaped spot moves, creating a moving spot pencil beam. In one embodiment, magnetic bearings are incorporated into the system to rotate the spin-roll at a very high speed (up to 20,000 rpm). Since there is no friction in magnetic bearings, the likelihood of failure due to dust intrusion or mechanical failure is minimized. This is beneficial considering the difficult and rugged environments in which the system may be deployed.

In addition, the spin-roll design has further advantages over the prior art disc wheel. The spin-roll has a lighter weight due to size and material composition and is more suitable for a transportable system due to its rugged design. Also, the system is easier to maintain since the cylindrical “field replacement part” is not assembled with the x-ray source, as is the case with a rotating wheel design. There is improved consistency for the x-ray spot energy density and spot size since the spin-roll provides a constant velocity flying x-ray spot instead of one that accelerates and decelerates through the inspection zone, as is the case with a rotating wheel design. In addition, the higher rotational velocity achieved with the spin-roll results in reduced scan time. The spin-roll chopper used in the present system is described in co-pending U.S. patent application Ser. No. 13/047,657, assigned to the Applicant of the present invention and herein incorporated by reference in its entirety.

In one embodiment, the compact x-ray source and the spin-roll are installed upon a platform that can be programmed to rotate at a speed chosen as a function of the platform's angular position. The overall result is the delivery of a customizable and therefore, optimized x-ray beam profile, with the x-ray beam uniquely characterized by the source, by the slit design and rotational speed of the spin roll, and by the beam being swept across the field-of-view by use of a platform with a user-programmable angular speed.

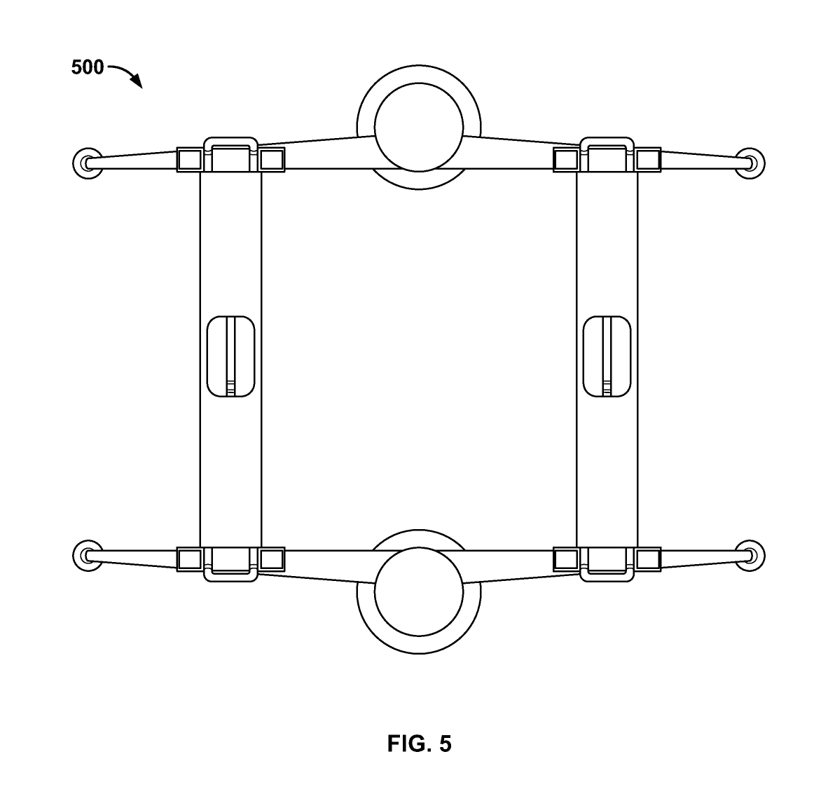

In various embodiments, the slim design of the assembled system as illustrated in FIG. 3 minimizes the footprint necessary to deploy the system. In an embodiment, the footprint for the assembled system is 62 inches long and 56 inches wide. Further, an operator positioned near the image display 318 would require an additional 12 inches in width, and assuming a 36 inches long queuing location at the entrance of the system, the operational footprint required would be approximately 98 inches long and 68 inches wide. FIG. 5 illustrates a top view of the screening system 500 displaying the operational footprint, in accordance with an embodiment of the present invention. FIG. 5 also illustrates the 36″ wide corridor, which provides comfortable walking space not found in conventional people-screening systems.

In an embodiment, the screening system of the present invention employs a compact flat-panel design of the x-ray detector enclosures. In an embodiment, a detector technology using a surface covered with a mat of scintillating fibers, which are read out on one end using photodiodes, or small photomultiplier tubes (PMTs) is employed. Scintillating fibers are made from light-weight polystyrene, and can be single- or multi-clad with low-refractive-index acrylics, improving the light yield. They are commonly available as square or round fibers in various diameters. In an embodiment, the screening system of the present invention employs a two min thick CaWO₄ scintillator screen, or a screen of similarly performing material, which is capable of completely stopping the reflected x-rays, producing about 6 optical photons per keV of incident x-ray energy. The light collection efficiency is about 30% into the PMTs, which have a quantum efficiency of about 25%. A half to one millimeter thick layer of plastic scintillating fibers is also 100% effective in stopping the reflected x-rays and produces more optical photons (about 8) per keV. However, the light collection efficiency is only 7%. Photodiodes have a quantum efficiency of up to 60%, partially offsetting the lower light collection efficiency. In one embodiment, avalanche photodiodes are used to improve the signal. An advantage of scintillating fibers is that they are extremely fast, with a decay time of about 10 ns, compared to the decay time of CaWO₄, which is 6 μs. This can allow for a system design with higher horizontal imaging resolution.

In another embodiment, the system employs one or more flat scintillating screens sandwiching wavelength-shifting fibers. In various embodiments, the two mats of scintillating fiber are read out through photodiodes, silicon photomultipliers, or small photomultiplier tubes. The scintillating screen material is used on one or more surfaces and wavelength-shifting fibers are used to pick up the scintillation photons and redirect them to the end of the fiber where they are read out by the photodetectors. Current systems use scintillating screen material with a large cavity wherein optical scintillation photons reflect from surfaces to be detected by large area glass photomultiplier tubes which are bulky and fragile. The use of scintillating screen material together with non-scintillating wavelength-shifting fibers, which pick up the scintillation light and redirect it through the wavelength shifting feature to emerge from the end of the fiber, allows for the modular detectors of the system to be thin, robust, and flexible.

In various embodiments, the detector panels are less than 0.5 inches thick and may be folded for transportation, as described above, resulting in a compact x-ray screening system.

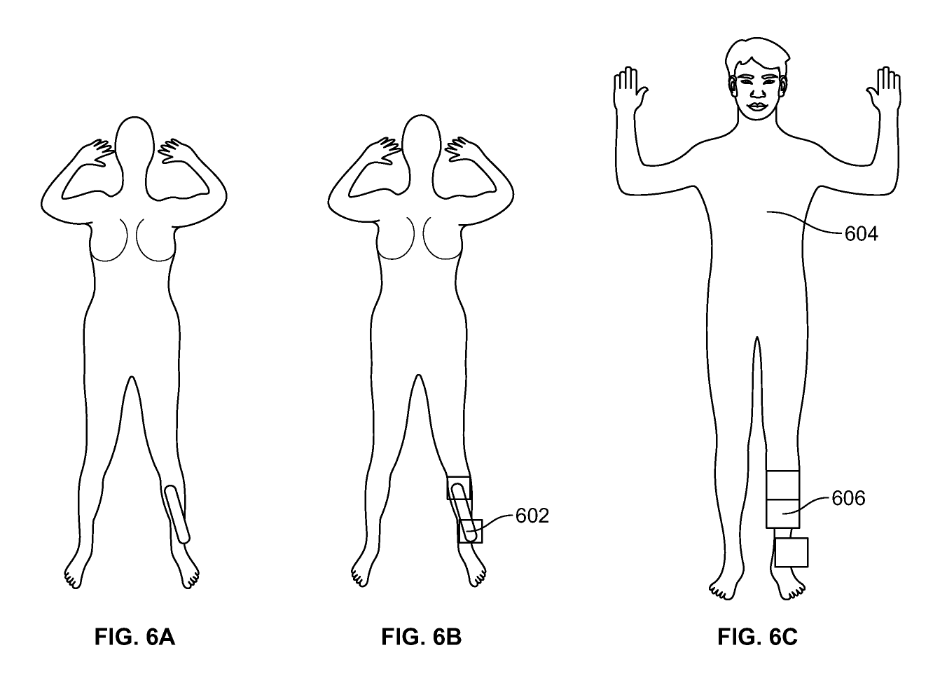

In various embodiments of the present invention, sophisticated filtering and image processing techniques are applied to the image acquired by the screening system. The image processing permits a series of machine vision techniques to automatically determine the presence of anomalies on a human body. In an embodiment, an acquired human body image is segmented into predefined body regions that take advantage of local homogeneity and symmetry to manipulate the image space such that contrast and edge detection algorithms can precisely identify the location of the anomaly. A mapping routine matches segmented body regions to a generic representative human figure (avatar) for display of ATR results to a screening operator without violating the privacy of the subject under inspection. FIG. 6A illustrates a typical backscatter X-ray image of a human body. FIG. 6B illustrates a backscatter X-ray image of a human body incorporating the results of ATR, depicting a gel-dynamite explosive 602 strapped to the left shin of the human body. FIG. 6C illustrates an avatar of a human figure which represents the backscatter X-ray image of a human body and incorporates the results of ATR, depicting a gel-dynamite explosive strapped to the left shin. The avatar 604 is displayed with the gel dynamite explosive 606 strapped to the left shin.

Various image processing techniques are described in co-pending U.S. patent application Ser. Nos. 12/887,510; 12/849,897; 12/142,978, and U.S. Pat. Nos. 7,826,589 and 7,796,733 which are all assigned to the Applicant of the present invention and herein incorporated by reference in their entirety.

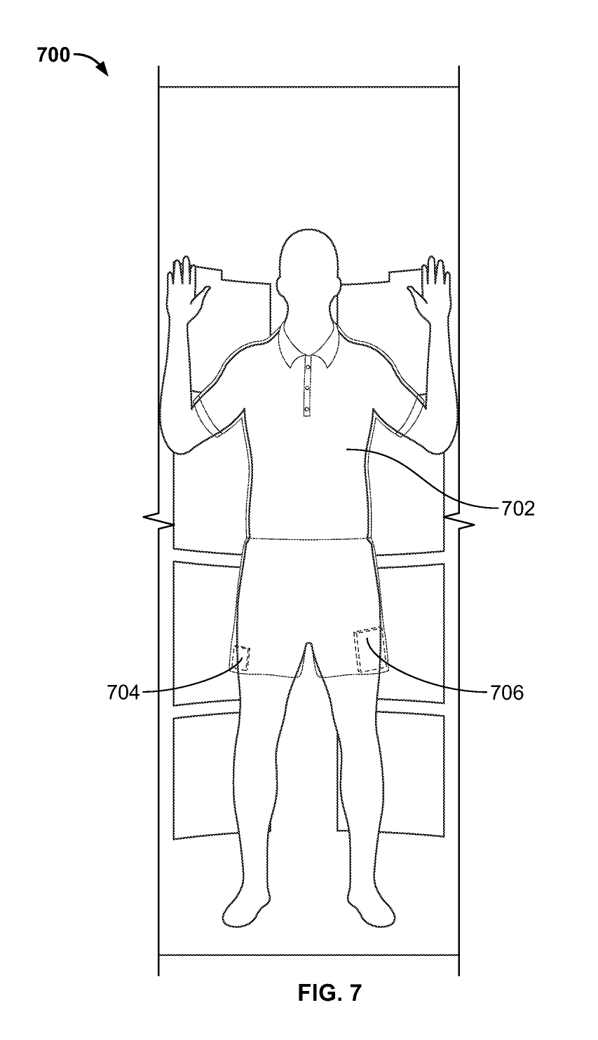

Detection of inorganic objects (predominantly metallic) in locations off-the-body (e.g., concealed in clothing) is particularly challenging for backscatter x-ray technology due to the absorbing nature of these materials and the lack of reflective background to create contrast. One option for the detection of metallic items in such scenarios is the integration of an EMD and application of fusion techniques. Therefore, in an embodiment, the screening system of the present invention utilizes a technique called “Active Background” for the detection of metallic items. Active Background technique takes advantage of the opposing set of detectors that are normally inactive during an x-ray backscatter scan. Using this technique, x-rays that pass by a subject under inspection are captured on the opposing set of detectors and inorganic materials that are off-the-body are identified more easily. FIG. 7 illustrates a typical Active Background x-ray image 700. The subject 702 has metallic objects, namely, keys 704 and a cellular telephone 706 in the pants pockets. The Active Background images are utilized by the same ATR algorithms that process the backscatter images and produce a single integrated decision.

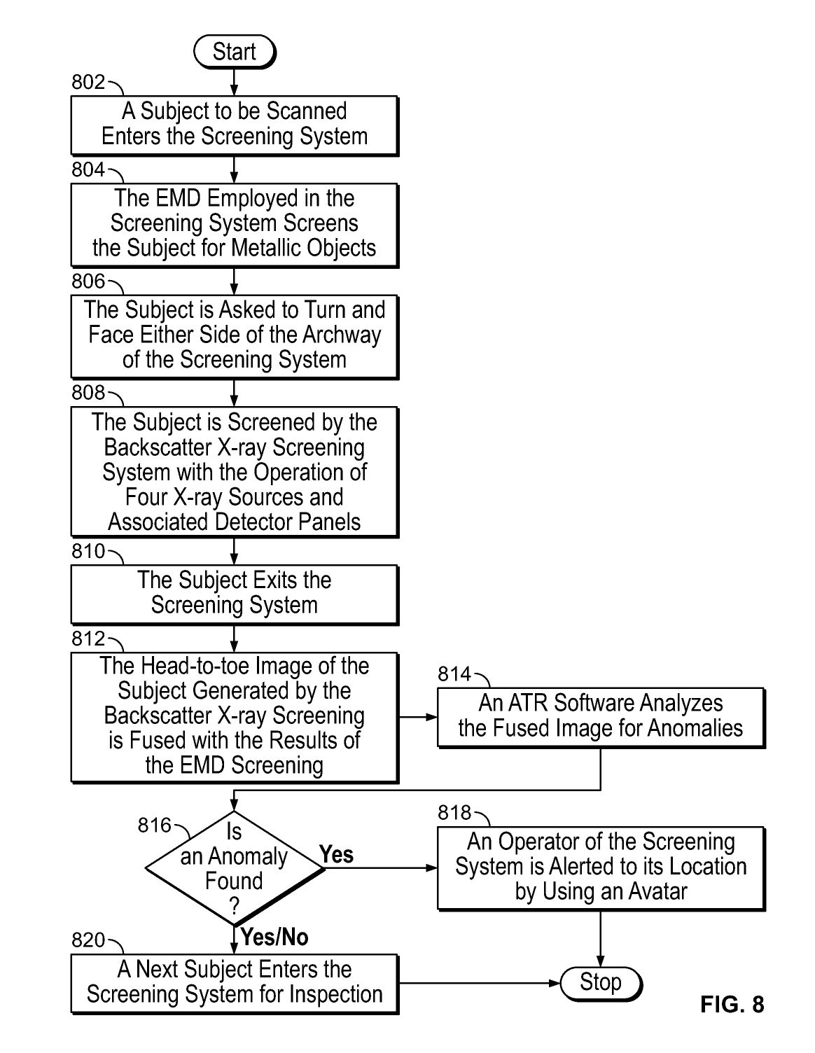

The active background concept employed in the present system is described, at least in part, in U.S. Pat. No. 6,665,373, which is assigned to the Applicant of the present invention and herein incorporated by reference in its entirety. Once powered up and calibrated, the system can be operated. In one embodiment, the system requires one person to operate. Preferably, the system has two operators to increase efficiency. In one embodiment, a first operator directs subjects into the archway while a second operator (screener) monitors the display. In accordance with an aspect of the present invention, the EMD and AIT (X-ray backscatter screening) systems are designed mechanically to avoid any interference between them and also maintain integrity of overall operating sequence as described with reference to FIG. 8 below.

FIG. 8 is a flowchart illustrating a method of operation of the screening system, in accordance with an embodiment of the present invention. At step 802, a subject to be screened enters the scanning system portal. At step 804, the EMD employed in the screening system screens the subject for metallic objects. In one embodiment, EMD screening occurs as the subject enters the archway. At step 806, the subject is asked to turn 90 degrees and face either side of the archway (an AIT panel) of the screening system. In an embodiment, the subject is requested to raise his or her hands above the head in such a manner that palms face forward, and an operator initiates the x-ray scan with a start button. At step 808, the subject is screened by the backscatter x-ray screening system with the automatic firing of each of the four x-ray sources in an overlapping time pattern. At step 810, the subject exits the screening system. At step 812, the head-to-toe image of the subject generated by the backscatter x-ray screening is fused with the results of the EMD screening. At step 814, an ATR software package analyzes the fused image for anomalies. At step 816, it is determined if an anomaly is detected in the fused image. If an anomaly is found, then at step 818, an operator of the screening system is alerted to its location by using an avatar (for privacy protection) that is displayed on a flat panel display embedded into one of the sections of the system and the subject is sent to a location for a secondary screening procedure. At step 820, a next subject enters the screening system for inspection. In various embodiments, each screening takes between 12-15 seconds, resulting in a throughput of about 240 to 300 people per hour.

The system of the present invention can be designed for various levels of automation and checks. Persons of ordinary skill in the art should appreciate that, in one embodiment, in a high level automated system, if the subject does not follow (or violates) the screening sequence (of first going through EMD screening followed by backscatter X-ray screening) then the operator is immediately alerted.

Hence, the screening system of the present invention combines the capability of AIT and Enhanced Metal Detection (EMD) with Automated Threat Recognition (ATR) enhancements. The screening system uses a combination of backscatter x-ray imaging technology with Walk-Through Metal Detection (WTMD) technology in one portable system enabling effective personnel screening to users requiring both sensitive detection and ultimate portability. Further, the screening system of the present invention meets stringent requirements of portability, modularity, and environmental robustness. The advanced technology used in the screening system translates into lighter components, improved ruggedness, improved portability, and improved ease of use.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive.

1. A modular inspection system, for detecting objects carried by or on a human subject, comprising:
first, second, third and fourth sections wherein each said section further comprises an X-ray source with integrated beam chopper, two backscatter X-ray detector panels and at least one metal detector panels;
first strapping means to hold together folded said first and second sections and form a portable first case; and
second strapping means to hold together folded said third and fourth sections and form a portable second case; wherein the first and second cases can be wheeled to and from a checkpoint.

2. The modular inspection system of claim 1, wherein each of the said sections comprise at least one cavity for housing a flat panel display along with control unit in one of the said cavities and rechargeable batteries in the remaining said cavities.

3. The modular inspection system of claim 1, wherein the first and second cases are mounted on respective first and second wheeled trolleys with handles.

4. The modular inspection system of claim 1, wherein the first and second cases are protected with first and second transport covers respectively during transportation.

5. The modular inspection system of claim 1, wherein each of the said sections weigh approximately 70 lbs.

6. The modular inspection system of claim 1, wherein each of the X-ray sources is a lightweight compact source integrated with a spin-roll chopper.

7. The modular inspection system of claim 6, wherein the integrated X-ray source and spin-roll chopper are rotated upon a programmable platform.

8. The modular inspection system of claim 6, wherein each of the X-ray sources scans a spot of X-rays over the human subject during backscatter X-ray scanning

9. The modular inspection system of claim 1, wherein the backscatter X-ray detector panels are flat surfaces covered with scintillating fibers that are read out using photodetectors.

10. The modular inspection system of claim 1, wherein the backscatter X-ray detector panels are one or more flat scintillating screens sandwiching wavelength-shifting fibers that are read out using photodetectors.

11. In a modular inspection system, for detecting objects carried by or on a human subject, a method comprising the steps of:
unfolding first and second sections from a first case and unfolding third and fourth sections from a second case; wherein each of the first, second, third and fourth sections comprise at least one X-ray source with integrated beam chopper, two backscatter X-ray detector panels and at least one metal detector panel;
latching the unfolded first section on top of the unfolded second section to form a first side;
latching the unfolded third section on top of the unfolded fourth section to form a second side;
holding the first and second sides together using two handle assemblies thereby forming the inspection system;
allowing the human subject to enter the inspection archway;
screening the human subject using the metal detector panels in the said sections to obtain first inspection data;
screening the human subject by operating the X-ray sources in the said sections and detecting the backscattered X-rays from the human subject using the backscatter X-ray detector panels to obtain second inspection data;
fusing first and second inspection data; and
analyzing the fused inspection data to automatically determine and alarm anomalies.

12. The method of claim 11, wherein each of the said sections comprise at least one cavity for housing a flat panel display along with control unit in one of the said cavities and rechargeable batteries in the remaining said cavities.

13. The method of claim 11, wherein each of the said sections weigh approximately 70 lbs.

14. The method of claim 11, wherein each of the X-ray sources is a lightweight compact source integrated with a spin-roll chopper.

15. The method of claim 14, wherein the integrated X-ray source and spin-roll chopper are rotated upon a platform which is user programmable.

16. The method of claim 14, wherein each of the X-ray sources scans a spot of X-rays over the human subject during backscatter X-ray scanning

17. The method of claim 11, wherein the backscatter X-ray detector panels are flat surfaces covered with scintillating fibers that are read out using photodetectors.

18. The method of claim 11, wherein the backscatter X-ray detector panels are one or more flat scintillating screens sandwiching wavelength-shifting fibers that are read out using photodetectors.

19. The method of claim 11, wherein assembly of the inspection system takes less than or equal to 5 minutes.
